(19) United States
(12) Patent Application Publication
(10) Pub. No.: US 2006/0287871 A1
(43) Pub. Date: Dec. 21, 2006

(54) Loyalty reward system and method for generating and tracking funds for third parties

(75) Inventors: Brian Carrozzi, Pacifica, CA (US); Ziad Nassar, Manhattan Beach, CA (US)

Correspondence Address: ROBERT E. KREBS;THELEN REID & PRIEST, P.O. BOX 640640, SAN JOSE, CA, 95164-0604, US

(73) Assignee: ROI Media LLC, a Nevada Limited Liability Corporation

(21) Appl. No.: 11/149,809

(22) Filed: Jun. 9, 2005

(51) Int. Cl. G06Q 99/00

(52) U.S. Cl. 705/1

(57) ABSTRACT

A server has a processor, an operating system (OS), a database, a tracking module, a crediting module, and a delivering module. The database includes a user's information, revenue statistics, and revenue allocation for at least one organization selected by a user. The tracking module includes tracking relevant user activities with a user ID. The crediting module includes crediting to at least one organization selected by the user in response to the tracking. The delivering module includes delivering information to the user in real-time. The information includes a total contribution made to at least one organization selected by the user and a total contribution made to at least one organization by a community.

### FIELD OF THE INVENTION

The present invention relates to a loyalty reward system and method for tracking contributions. More particularly, the present invention relates to a system and method for tracking revenue contributions to selected third parties.

### BACKGROUND OF THE INVENTION

The popularity of the World Wide Web (WWW) has led to the commercialization of this new medium. As a result, the web has become a significant new medium for commerce, which is referred to as electronic commerce or E-commerce. Vendors offer goods and services for sale via various web sites. For example, a vendor may sell items over the web via an online store. Security mechanisms, such as the well-known Secure Sockets Layer (SSL) protocol standard have been developed to provide secure electronic transactions of sensitive data (e.g., encryption of financial data) over the Internet.

Advertising on the web represents another strategy for generating revenue through the popularity of the web. For example, a website can sell advertising space on its frequently visited home page (e.g., www.yahoo.com). Other means of advertising include banners and pop ups. The web user interaction with a popular website allows the website to generate revenue through advertising means. However, such advertising means generate revenue only for the owner of the web site.

Accordingly, a need exists for a system for contributing a portion of the revenue generated by the user activities to one or more organizations selected by the user, and tracking the contribution in real-time. A primary purpose of the present invention is to solve these needs and provide further, related advantages.

### BRIEF DESCRIPTION OF THE INVENTION

A server has a processor, an operating system (OS), a database, a tracking module, a crediting module, and a delivering module. The database includes a user's information, revenue statistics, and revenue allocation for at least one organization selected by a user. The tracking module includes tracking relevant user activities with a user ID. The crediting module includes crediting to at least one organization selected by the user in response to the tracking. The delivering module includes delivering information to the user in real-time. The information includes a total contribution made to at least one organization selected by the user and a total contribution made to at least one organization by a community.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram schematically illustrating a system for tracking contributions in accordance with one embodiment.

FIG. 2 is a diagram schematically illustrating an apparatus for tracking contributions in accordance with one embodiment.

FIG. 3 is a flow diagram schematically illustrating a method for tracking contributions in accordance with one embodiment.

FIG. 4 is a flow diagram schematically illustrating a method for tracking contributions in accordance with another embodiment.

FIG. 5 is a flow diagram schematically illustrating methods for tracking a user activity in accordance with one embodiment.

FIG. 6 is a flow diagram schematically illustrating methods for delivering information as to contribution in accordance with one embodiment.

FIG. 7 is a flow diagram schematically illustrating methods for receiving funds in accordance with one embodiment.

### DETAILED DESCRIPTION

Embodiments of the present invention are described herein in the context of a system and method for computing contributions based on user activity. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with one embodiment of the present invention, the components, process steps, and/or data structures may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, or a stand-alone device. The process can be implemented as instructions executed by such hardware, hardware alone, or any combination thereof. The software may be stored on a program storage device readable by a machine.

In addition, those of ordinary skill in the art will recognize that devices of a less general purpose nature, such as hardwired devices, field programmable logic devices (FPLDs), including field programmable gate arrays (FPGAs) and complex programmable logic devices (CPLDs), application specific integrated circuits (ASICs), or the like, may also be used without departing from the scope and spirit of the inventive concepts disclosed herein.

In accordance with one embodiment of the present invention, the method may be implemented on a data processing computer such as a personal computer, workstation computer, mainframe computer, or high performance server running an OS such as Solaris® available from Sun Microsystems, Inc. of Palo Alto, Calif., Microsoft® Windows® XP and Windows® 2000, available form Microsoft Corporation of Redmond, Wash., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet.

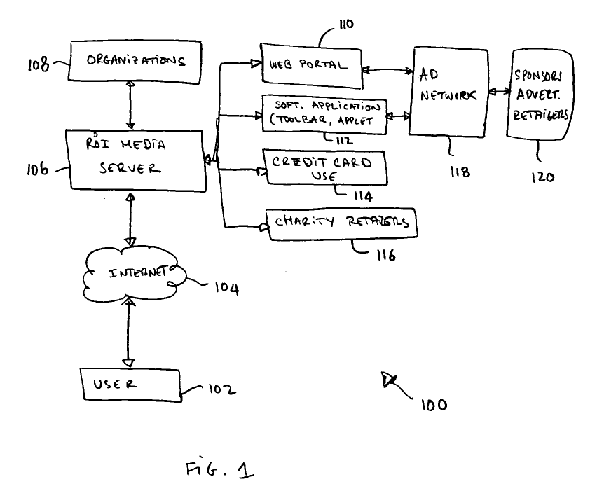

FIG. 1 illustrates a system 100 for tracking contributions based on a user activity. A user 102 accesses a server 106 (ROI Media server) through a network, such as the internet 104. The user 102 is for example, a web or internet user. The user 102 selects the organization or charities 108 of choice that he/she wishes to donate to.

The user 102 generates revenue for their selected organization(s) 108 by accessing a web portal 110 connected to an advertising network 118 that is supported by advertisers, sponsors, and retailers 120. The web portal 110 may include news content, a search engine/directory, sports content, weather content, etc. The web portal 110 is connected to the server 106. The web portal 110 displays advertisements to generate revenue for the organization 108 selected by the user 102. A network of advertisers comes together to advertise within the advertising network 118 which is accessed by both the portal network 110 and the third party software network 112. Together, these networks 110 and 112 make up the advertising network. Advertisers, sponsors, and retailers advertise and promote their offers within the advertising network 118.

The user 102 may also generate revenue by downloading and using a software application 112, such as a toolbar application or a consumer shopping companion software. The application software communicates with a advertising network 118 that is supported by advertisers, sponsors, and retailers 120. The toolbar software application 112 may be delivered through an executable file from the ROI Media server 106 and may be loaded onto the user's computer 102. The software application 112 may serve advertisements as well as track all advertising revenue generated for the organization 108 selected on behalf of the user 102.

The user 102 may also generate revenue by obtaining and using a credit card 114 associated with the organization or charities 108. A percentage of the credit card expenditure would be contributed to the selected organization 108. The credit card 114 may include a co-branded credit card. All revenue generated by the credit card 114 may be sent and associated with an account of the user 102. The account is administered and the contributions in the account may be divided among the organizations 108 selected by the user 102 according to account allocation rules set up by the user 102.

The user 102 may also generate revenue for the selected organization 108 by directly donating or contributing to a charity retailer 116. Partner retailers 116 may also contribute a percentage of a user's 102 sales back to the user's 102 organization(s) 108 of choice. A third party software may track the user's 102 purchases with member retailers 116 inside and outside of the web portal 110. Revenue generated is updated to the user's 102 account and divided among the organizations 108 selected by the user 102 according to account allocation rules set up by the user 102.

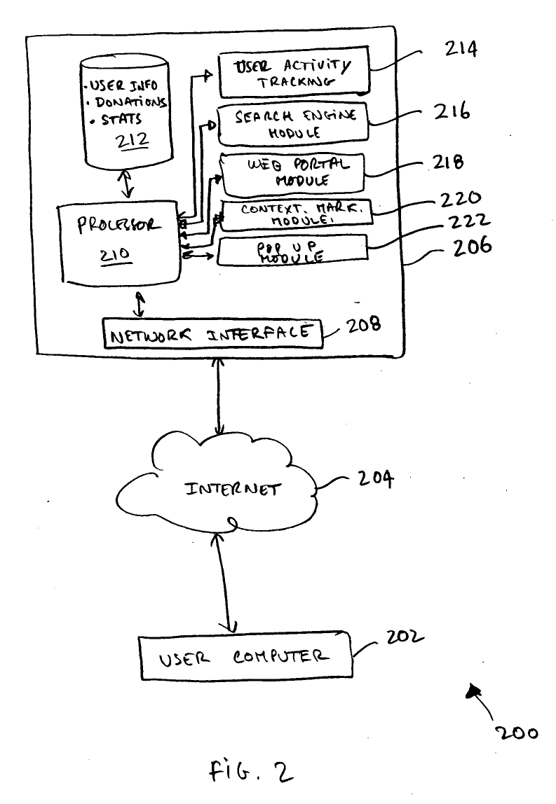

FIG. 2 illustrates a system 200 for tracking contributions based on a user activity. A user computer 202 connects with a server 206 via a network 204, such as the internet. The user computer 202 interfaces with the server 206 via a network interface 208.

The server 206 may include a processor 210, a database 212, a user activity tracking module 214, a search engine module 216, a web portal module 216, a contextual marketing module 220, and a pop up module 222.

The processor 210 processes all information concerning any activity and interaction with each individual user. Processor 210 communicates with the database 212, the user activity tracking module 214, the search engine module 216, the web portal module 216, the contextual marketing module 220, and the pop up module 222. The database 212 stores the user's account information, revenue statistics, asset allocation with respect to the selected organizations by the user.

The user activity tracking module 214 tracks all revenue generated by each individual from all revenue sources available within the advertising network 118. This will track CPM, CPC, CPA, and CPS revenue.

The search engine module 216 communicates with processor 210 and reports revenue back to the user's account within the database 212. Revenue is generated and tracked when a user clicks on an advertiser's “sponsored” listing.

The web portal module 218 communicates with the processor 210 and reports revenue back to the user's account within the database 212. Revenue is generated and tracked on a CPM, CPC, CPA, and CPS basis.

The contextual marketing module 220 communicates with the processor 210 and reports back revenue to the user's account within the database 212. Revenue is generated and tracked on a CPM, CPC, CPA, and CPS basis. Contextual marketing advertisements are displayed according to the context of the page that the user is visiting within the advertising network (both software network 112 and web portal network 110).

The pop up module 222 is separate from the contextual marketing module 220 and serves pop up and pop under advertisements within the advertising network 118 on a contextual marketing, behavioral marketing, and run of network (general, non-targeted) basis.

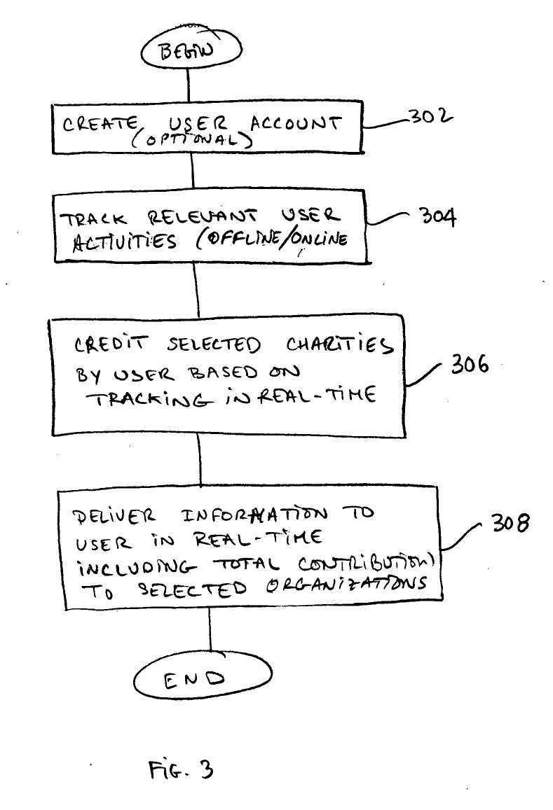

FIG. 3 is a flow diagram 300 illustrating a method for tracking contributions to selected organizations based on a user activity. At 302, a user creates an account by entering their full name, postal address, email address, date of birth, login, password, and the organizations that they wish to donate to. For example, in the user account, the user can select up to three charities and allocate a certain percentage to each organization. For example, Organization 1=American Red Cross, 35%, Organization 2=American Cancer Society, 35%, Organization 3=Greenpeace, 30%. A user does not have to create an account to use the web portal or other aspects of the ad network.

At 304, for online means, once a user creates an account, a “cookie” is placed on the user's computer to allow the system to recognize that specific user's unique member ID. Revenue or contributions are tracked on a CPM, CPA, CPC, and CPS basis and associated with the unique ID of the user to attribute revenue. When a user signs up for a co-branded credit card, his or her co-branded credit card account will correlate to the user's unique ID from his online account. As a result, a percentage of all transactions made offline with this credit card is updated and applied directly to the user's online account. Revenue generated offline also supports organizations selected by the user using the percentage allocation from his/her online account settings.

At 306, revenue that the user generates for his/her organization is tracked in real-time and updated to the user account in real-time. In accordance with one embodiment, revenue can be generated online through CPA, CPM, CPC, and CPS campaigns. In accordance with another embodiment, revenue can be generated offline by making purchases offline using the co-branded credit card.

At 308, revenue generated by the user is delivered in real-time to the user's account as well as the toolbar and/or portal “community revenue counter”. The community revenue counter is a real-time counter that displays the total contributions made by the online and offline community in real-time to a selected organization in real-time.

FIG. 4 is a flow diagram 400 illustrating a method for tracking contributions to selected organizations based on a user activity in accordance with another embodiment. At 402, a percentage of the affiliate commissions received from advertisers, retailers, and sponsors is credited to the users account based on the action taken by the user. If the user (recognized by unique user ID) sees a banner and that banner was sold to the advertiser on a cost per 1000 impression (CPM) basis, then the user's account is credited a percentage of the revenue generated from that impression. If the user clicks on a banner and it is a cost per click (CPC) campaign, the user generating the action is credited a percentage of the revenue generated from that click. If the user makes a purchase through one of the affiliated retailers, a percentage of the affiliate commission is credited back to the user. If the user signs up for an offer on a cost per action (CPA) campaign, a percentage of the revenue generated off of that lead and/or registration is credited to the user. If the user uses a co-branded credit card, a percentage of all transactions goes directly into the user's account. A percentage of all revenues generated by the user both online and offline goes to the user's account in real-time when the user's ID is recognized.

At 404, a percentage of revenues generated by the user is credit according to the user's account settings, identified by the user's ID. The user's account and distribution settings determine the payout allocation to the user's organizations of choice. For example, if the user has three charities that he wants to give to, he can set each up to receive the following percentages of total funds, 75%, 15%, 10%. For example, if he has $100 in his account, the three organizations would receive accordingly $75, $15, $10 respectively.

At 406, revenue generated by the user is viewable in a “real-time” counter which will be displayed on the homepage of the portal, in the toolbar on the user computer, and through other means such as an RSS feed.

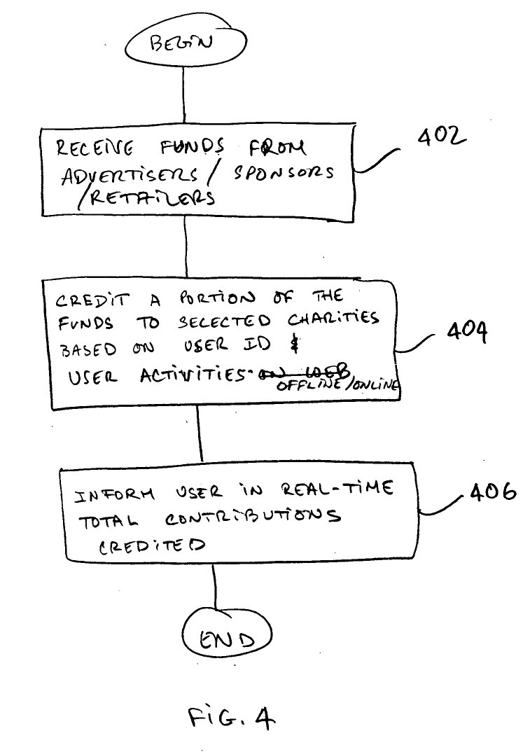

FIG. 5 is a flow diagram schematically illustrating methods for tracking a user activity in accordance with one embodiment. All user activity 502 is tracked via cookies and USER ID within the online and offline network so as to credit the organizations selected by the user for all creditable actions. Ways of tracking user activity includes, but is not limited to: a contextual marketing component 504, a toolbar 506, a pop-up/pop-under 508, a portal webpage 510, a search engine 514, a credit card use 516, other methods 518.

The contextual marketing component 504 includes text keyword highlighting on the content of third party and proprietary websites and/or portals. Contextual marketing would also pop up advertisements based on the context of the content in which the user is browsing. For example, if a user is visiting website A, a pop-up would display from competitor website B. A percentage of revenue generated off of the contextual marketing advertisement would go into the user's account.

The toolbar 506 tracks the user's activities within the toolbar and includes a contextual marketing component 504 as well that can be bundled within the toolbar product or downloaded as a stand alone product. Through the toolbar 506, contextual pop up advertisements 504 can be served, the search engine 514 can be utilized, and/or contextual keyword highlighting can be utilized. All revenue is reported in real time and is updated within the real-time revenue counter within the toolbar.

Pop-ups and pop-unders 508 are launched on websites as well as through the toolbar 506. A percentage of all revenue generated by the user will be credited to the user's account.

The portal web page 510 tracks the user via the unique User ID. If there is no User ID found, then a percentage of all revenue generated by that user will go to a “default” organization. Within the portal, revenue is tracked on a CPM, CPA, CPS, and CPC basis. Search engine CPC revenue is also tracked.

Retailer activity 512 (cost per sale) is also tracked through the shopping section of the portal. Revenue will be updated into the real time revenue counter within the portal

Revenue from search engine 514 is tracked across affiliate search engines on a Cost Per Click (CPC) basis. When a user clicks on a “sponsored advertiser listing” from the search engine in the portal or in the toolbar, a percentage of the revenue generated from that click goes to the user's account via the user's unique ID.

A user's credit card activity 516 can be tracked via their unique user ID. A percentage of all of their transactions is credited to their account at which point it is divided among the organizations selected by the user according to the user's organization percentage allocation.

Other methods 518 may include software developed by third parties to track purchases from retailers. When a user downloads this software, the user's account will automatically be credited for purchases made at “online” partner/retailers websites. For example, rather than having to shop through the web portal, a user can simply go to a partner site such as Travelocity.com. When a user goes to the URL http://www.travelocity.com, the software will recognize that merchant as a partner and will append the Travelocity URL with the partner ID and USER ID so that the organizations selected by the user earn revenue.

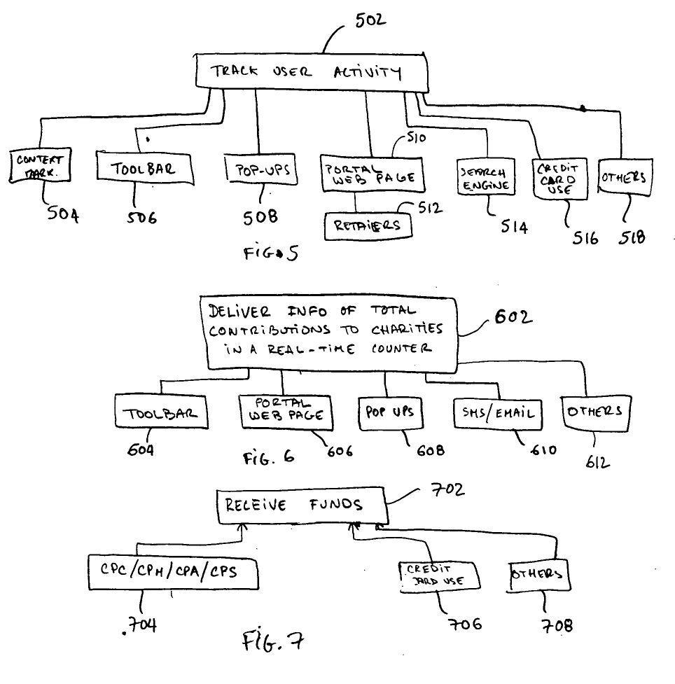

FIG. 6 is a flow diagram schematically illustrating methods for delivering information as to contribution in accordance with one embodiment. Once contribution revenue is calculated and attributed to a particular USER ID, the contributions are communicated to the database 212. The database 212 sends the revenue numbers to the USER ID's account where their settings and allocation percentages determine how the Total Revenue Contribution is divided. At the same time, the database 212 updates the “revenue counter” in real-time, adding the new contributions to the Total Community Revenue counter. The revenue counter and the user's account are updated in real-time.

One way of displaying the revenue/contribution counter is via a toolbar 604 displayed on the user computer. The toolbar 604 tracks contributions from revenue generated through search engine revenue, pop up revenue, contextual marketing click revenue, and cost per acquisition revenue. When revenue is generated by the user through any of the above mentioned means, the revenue is updated in real time within the toolbar, portal real time “community revenue counter”, and the user's account.

When a user visits a portal web page 606, the user may see many different advertisements and can generate revenue by viewing banners and pop ups, clicking on banners and pop ups, filling out advertiser/sponsor offers; clicking on sponsored search engine listings and contextual keyword listings, and making purchases through affiliate retailers. All tracked revenue/contribution is updated when available in real-time to the real-time “community revenue counter” and the user's account.

When a user surfs the web, pop-ups and pop-unders 608 can be displayed to the user from within the web portal 606 and through the toolbar 604. Revenue can be generated from the pop ups 608 by viewing the pop ups 608, clicking on the pop ups 608, and/or filling out the offers on the sponsored advertiser pop ups 608. Revenue is updated in real-time to the community revenue counter and the user's account.

Email and SMS 610 can also generate revenue for the user's organization by the user viewing an advertisement, clicking on an advertisement, and/or filling out/signing up for an advertiser sponsored offer, and making a purchase from a sponsor retailer (CPM, CPC, CPS, and CPA revenue models). Revenue generated is updated in real-time to the real-time counter and the user's account.

Other means 612 may include third party software that can be used for tracking affiliate retailer revenue generated by the users. All revenue generated by the user's use of this software is uploaded in real-time (when available) to the community revenue counter and the user's account. Another means may include using the co-branded credit card online to generate revenue for the user. This revenue is posted to the user's account in real-time as well as updated within the community revenue counter in real-time.

FIG. 7 is a flow diagram schematically illustrating methods for receiving funds in accordance with one embodiment. Funds are received from the advertisers/sponsors in a number of ways (both online and offline). The funds are posted to individual user's accounts. One way to generate revenue is through CPM/CPC/CPA/CPS 704.

In Cost Per 1000 Impressions (CPM), an advertiser has the option of paying for advertising on a CPM basis which is defined as the cost for one thousand impressions (via banners, pop ups, email, etc.). For example, an advertiser purchasing on a CPM basis may pay $2 CPM, meaning that 1000 impressions will cost a total of $2. This means that each banner impression that a visitor sees from this campaign is equal to $ 2/1000, or $0.002. If a user sees this impression within the web portal 110 or network 118, the user would immediately be credited in real time with a percentage, for example, 50% of the revenue or $0.001 to their individual member account.

In Cost Per Click (CPC), an advertiser has the option of paying for advertising on a CPC basis which is defined as the cost for a visitor clicking on their advertisement (delivered via banners, pop ups, search engine listings, email, etc.). For example, an advertiser purchasing on a CPC basis may pay $1 CPC, meaning that one click will cost a total of $1. If a visitor clicked on a CPC advertisement within web portal 110 or network 118, they would immediately be credited in real time with, for example, 50% of the revenue or $0.50 to their individual member account.

In Cost Per Acquisition (CPA), sometimes referred to as Cost Per Lead, an advertiser has the option of paying for advertising on a CPA basis which is defined as the cost for a visitor to generate a lead or registration stemming from an initial view of an advertisement through banners, pop ups, email, search engine sponsored listings, etc. For example, an advertiser purchasing on a CPA basis may pay $10 CPA, meaning that one lead or registration will cost a total of $10. If a user filled out an offer or generated a lead for an advertiser within web portal 110 or network 118, the user would immediately be credited in real time with, for example, 50% of the revenue or $5 to their individual member account.

In Cost Per Sale (CPS), an advertiser/retailer has the option of paying for advertising on a CPS basis which is defined as the percentage of commission given back to a website affiliate from an advertiser/retailer after the website's visitors make a purchase on the advertiser/retailer's site. For example, an advertiser/retailer paying its affiliates on a CPS basis may pay 10% commission, meaning that the advertiser/retailer will give 10% of every $1 spent to the website affiliate that referred the visitor to shop at the advertiser/retailer's site. If a user (member) from web portal 110 was referred to the advertiser/retailer's site and made a $100 purchase, web portal 110 would be credited with 10% of the purchase or $10 commission. For example, 50% of that commission or $5 would be credited to the individual member's account.

Another way to receive funds is through a co-branded credit card 706. A user or member of the community of the server 106 may be able to sign up for the co-branded credit card 706 in which a percentage, for example, 1% of all transactions will go to organization(s) selected by the user. A user signs up and receives the credit card which will be linked to the user online account. For example, if that user spends $1000, 1% goes back to their account to support their selected organizations. In this case $10 goes back to the user's account.

Other ways 708 to receive funds include business-to-business product where merchants can use a merchant account service and have a percentage of every credit card transaction generated by their customers go to the business' organization(s) of choice. For example, a business signs up for a merchant account service. When the business signs up with the merchant account service, web server 106 receives a percentage of the discount rate (amount charged by the merchant processor) for every credit card transaction made with that business. A percentage of the discount rate will be credited to the business owner's account (his account will be like a normal user account and will give money to organizations according to the business user's account allocation settings). For example, if Business X signs up for Merchant Account Service X, a percentage of the merchant processor's revenue, derived from the ‘discount rate’ charged by the merchant processor, will be credited to the business user account. If the discount rate is 1.75%, and the merchant processor revenue fees, less Merchant Bank, Visa/MasterCard and any other interchange fees, are 0.25%, the merchant processor will credit web server 106 with 50% of the merchant processor's revenue, or 0.125% of the transaction. The 0.125% will be divided between web server 106 and the business user's account. Thus, 0.0625% of all credit card transactions made with Business X will go to the business user's account.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for generating revenue to at least one organization selected by a user:
tracking relevant user activities with a user ID;
crediting the at least one organization in response to said tracking; and
delivering information to the user in real-time, the information including a total contribution to the at least one organization by the user, and a total contribution to the at least one organization by a community.

2. The method of claim 1 wherein said tracking includes:
tracking the relevant user activities online.

3. The method of claim 2 wherein said tracking includes:
providing a web portal associated with the user ID.

4. The method of claim 2 wherein said tracking includes:
uploading a software application to the user, the software application associated with the user ID.

5. The method of claim 1 wherein said tracking includes:
associating a credit card with the user ID; and
tracking transaction amounts from the credit card.

6. The method of claim 1 wherein said crediting includes:
receiving funds in response to the relevant user activities online and offline;
crediting a percentage of the funds to the at least one organization selected by the user.

7. The method of claim 6 wherein said receiving includes revenue generating means selected from a cost per click (CPC) campaign, a cost per impression (CPM) campaign, a cost per acquisition (CPA) campaign, a cost per sale (CPS) campaign, and a credit card use.

8. The method of claim 1 wherein said delivering includes:
displaying a real-time counter on a toolbar loaded on the user computer, the real-time counter including the information.

9. The method of claim 1 wherein said delivering includes:
displaying a real-time counter on a portal web page, the real-time counter including the information.

10. The method of claim 1 wherein said delivering includes:
displaying a popup on the user computer, the pop up including a real-time counter, the real-time counter including the information.

11. A program storage device readable by a machine, tangibly embodying a program of instructions executable by the machine to perform a method for generating revenue to at least one organization selected by a user comprising:
tracking relevant user activities with a user ID;
crediting the at least one organization in response to said tracking; and
delivering information to the user in real-time, the information including a total contribution to the at least one organization by the user, and a total contribution to the at least one organization by a community.

12. A server comprising:
a processor;
a database coupled to said processor, said database including a user information, revenue statistics, and revenue allocation for at least one organization selected by a user;
a tracking module coupled to said processor;
a crediting module coupled to said processor; and
a delivering module coupled to said processor.

13. The server of claim 12 wherein said tracking module includes:
means for tracking relevant activities online of the user with a user ID.

14. The server of claim 13 wherein said tracking module includes:
means for providing a web portal associated with the user ID.

15. The server of claim 13 wherein said tracking module includes:
means for uploading a software application to the user, the software application associated with the user ID.

16. The server of claim 12 wherein said crediting module includes:
means for receiving funds in response to the relevant user activities online and offline;
means for crediting a percentage of the funds to the at least one organization selected by the user.

17. The server of claim 12 wherein said delivering module includes:
a real-time counter on a toolbar loaded on the user computer, the real-time counter including a total contribution to the at least one organization by the user, and a total contribution to the at least one organization by a community.

18. The server of claim 12 wherein said delivering module includes:
a real-time counter on a portal web page, the real-time counter including a total contribution to the at least one organization by the user, and a total contribution to the at least one organization by a community.

19. The method of claim 12 wherein said delivering includes:
a pop-up/under on the user computer, the pop-up/under including a real-time counter, the real-time counter including a total contribution to the at least one organization by the user, and a total contribution to the at least one organization by a community.

20. A system for generating revenue comprising:
a client for selecting at least one organization; and
a server coupled to said client;
wherein said server includes:
tracking means for tracking relevant activities on the client;
crediting means for crediting the selected at least one organization in response to said relevant activities; and
delivering means for delivering information to the client in real-time, the information including a total contribution to the selected at least one organization, and a total contribution to the selected at least one organization by a community.
